(19) United States
(12) Patent Application Publication
(10) Pub. No.: US 2014/0158040 A1
(43) Pub. Date: Jun. 12, 2014

(54) Acronym Expansion List

(71) Applicant: Leonard Reichlin, Everett, WA (US)

(72) Inventor: Leonard Reichlin, Everett, WA (US)

(21) Appl. No.: 14/178,958

(22) Filed: Feb. 12, 2014

(51) Int. Cl. B42D 9/00

(52) U.S. Cl. CPC B42D 9/00
USPC 116/234

(57) ABSTRACT

A new means of listing the acronyms, and associated expanded phrases thereof, presented in a book, periodical or other printed volume. The embodiment of my acronym expansion list consists of a list that is printed in, included with or attached to a publication. If detached, the list can be used as a bookmark but can also be quickly referenced to find the related expanded term of any listed acronym and can optionally be used to locate the place in the text where the expanded term is further explained.

### CROSS-REFERENCE TO RELATED APPLICATIONS

None.

### FEDERALLY SPONSORED RESEARCH

Not applicable

### SEQUENCE LISTING

Not Applicable

### BACKGROUND

This embodiment of my acronym expansion list relates to a place-marker for a book or periodical (commonly called a bookmark) generally, and to its use as a printed acronym reference guide.

Bookmarks are as old as books. They've surely been in use since the first bound documents were printed. Everyone can recall strings or fabric ribbons bound into large volumes such as the Bible, Koran or Torah, used to mark a passage of text.

Many enhancements on the simple idea of marking a place in a book have been previously patented. Patents U.S. Pat. No. 2,543,182 to Lang (1949 May 24), U.S. Pat. No. 8,307,776 to Brooks (2012 Nov. 13), U.S. Pat. No. 4,898,115 to Bowlay-Williams (1990 Feb. 6), U.S. Pat. No. 1,338,861 to Frame (1920 May 4), and U.S. Pat. No. 5,515,809 to Weinberg (1996 May 14) describe simple to elaborate means of marking not only a specific page, but also a specific line on a page. Unfortunately, their function is limited to marking a location in the text.

Additionally, patents U.S. Pat. No. 6,056,492 to Hudson (2000 Feb. 2), U.S. Pat. No. 4,614,364 to Bortner (1986 Sep. 30), U.S. Pat. No. 5,713,606 to Kleinberg et al (1998 Feb. 3) and U.S. Pat. No. 2,590,615 to Heckendorn (1952 Mar. 25) are examples of detachable bookmarks. In these previous embodiments the bookmark is incorporated into the jacket or binding of a book, is detachable by the end user and has the added utility of providing coupons, special offers or contact information possibly of interest to the book reader. These previous patents attempt to increase the utility of a simple bookmark by addressing practical needs beyond simply marking a page. However, none of them addresses a specific need experienced by many readers; referencing the meaning of an acronym encountered in a document being read.

Consider the challenge for an individual reading a technical, legal or scientific document if the reader is not an expert in the field being discussed. The number of new terms presented, and the particular usage of common terms in the specialized context of a complex subject can be overwhelming. Despite these problems, acronyms are essential mnemonic devices and need to be more fully utilized but become a particular challenge when encountered in great number.

Especially challenging are the acronyms that are prevalent in many technical documents. Most writers of non-fiction use acronyms; they practice “acronymity”. After birthing their literary offspring, they often leave them as orphans. The reader may remember the acronym upon first introduction, but upon subsequent readings may find herself searching in the index; a needless waste of time.

An additional problem is presented by acronyms adopted from a foreign language. The letters of the acronym may not directly correspond to the initial letters of the phrase the acronym represents. An example would be the Spanish acronym FARC. Though commonly referred to in English as the Revolutionary Armed Forces of Colombia, FARC represents the equivalent Spanish phrase Fuerzas Armadas Revoluciones de Colombia, a famous or perhaps infamous organization. Similarly, PRI represents the Spanish phrase Partido Revolucionario Institucional, but commonly referred to in English as the Institutional Revolutionary Party.

### SUMMARY

My embodiment is directed at providing a new additional use for the common bookmark by making it also a quickly accessible reference guide. It is a pre-printed acronym expansion list, more particularly described as an alphabetical listing of acronyms used within a particular printed text, a full spelling of the phrase each acronym represents and a reference to the page location of first introduction.

### DRAWINGS—DESCRIPTION

FIG. 1 is an illustration of an Acronym Expansion List attached by perforations to the front flyleaf of a book.

FIG. 2 is an illustration of an Acronym Expansion List attached by perforations to the dustcover of a book.

FIG. 3 is an illustration of an Acronym Expansion List attached to the flyleaf of a book using releasable adhesive.

FIG. 4 is an illustration of an Acronym Expansion List as an insert marking the beginning of a section of a book.

FIG. 5 is an illustration of an Acronym Expansion List detached from a book; revealing the relationship between the acronym listing, the associated phrase and the text page references.

FIG. 6 is an illustration of a detached Acronym Expansion List used as a bookmark

### DRAWINGS—REFERENCE NUMERALS

10 separable card

12 printed volume

14 perforations

16 area for acronyms

18 area for associated phrases

20 area for page references

22 releasable adhesive

24 printed dust jacket

26 foreign language acronym expansion

### DETAILED DESCRIPTION

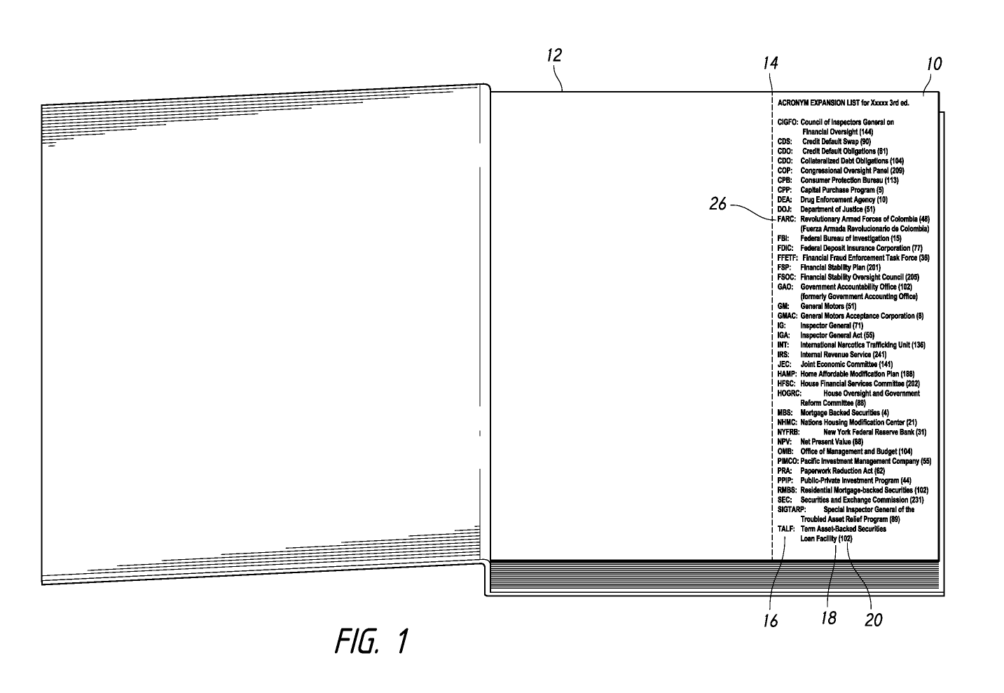

All described embodiments, as illustrated in FIGS. 1-6, include a pre-printed acronym expansion list, more particularly described as an alphabetical listing of the acronyms used within a particular printed text, a full spelling of the phrase each acronym represents and a reference to the page location of first introduction. FIGS. 1-6 all show the preferred positioning of an area for acronyms 16, an area for associated phrases 18 and an area for page references 20.

FIG. 1 illustrates one embodiment of my acronym expansion list printed on a separable card 10, attached to the front flyleaf of a printed volume 12, but separable at a line of perforations 14. The separable card 10 can be made of many different durable materials, but for cost-effective construction may be made from heavy paper card stock. Dimensions of the separable card 10 may be any practicable size, but preferably from one third to one half the width of the associated printed volume 12.

FIG. 1 also illustrates an example of a foreign language acronym expansion 26.

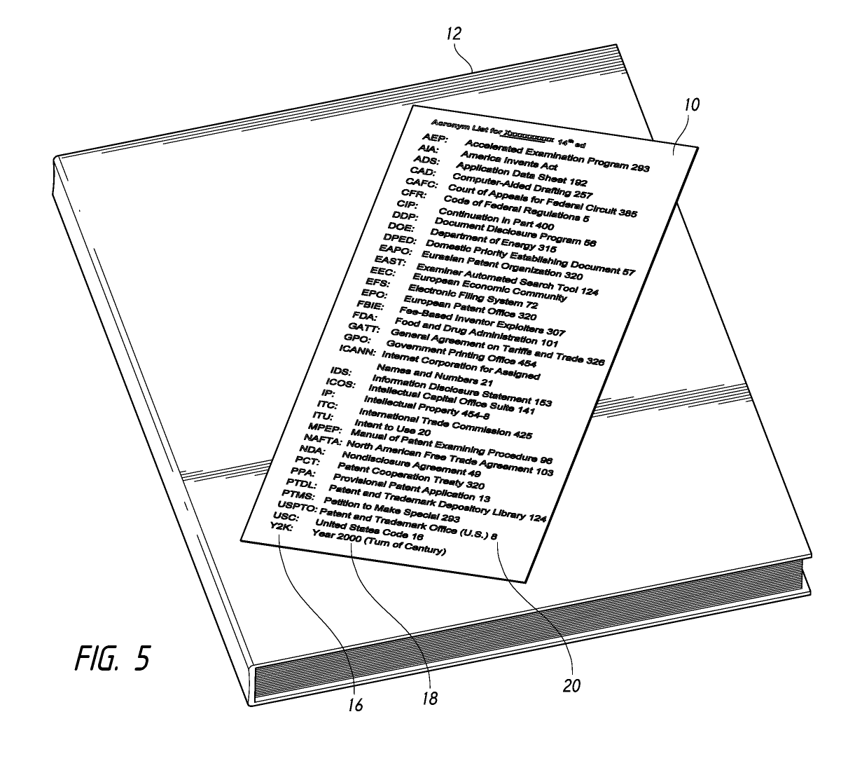

### Operation—FIGS. 5 & 6

FIG. 5 represents the acronym expansion list 10 in any of the above embodiments, detached from the printed volume 12.

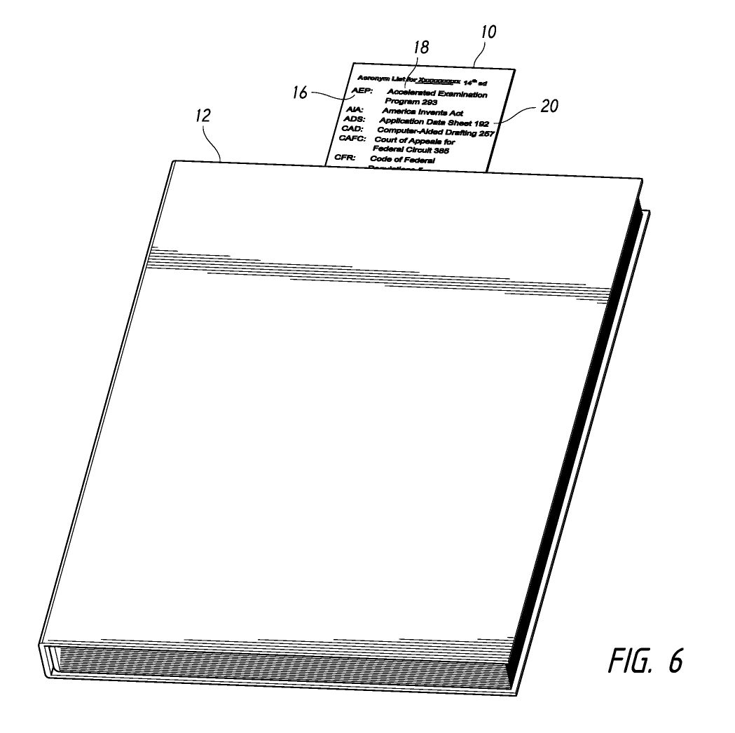

FIG. 6 demonstrates an acronym expansion list 10 in use as a temporary placeholder in a printed volume 12.

In operation a reader simply removes the acronym expansion list 10 from its printed volume 12 and uses it as a conventional bookmark. When the reader encounters an unfamiliar acronym in the printed volume 12 the reader may reference the acronym expansion list 10 for an acronym in question and, if desired, use the acronym expansion list 10 to mark the present reading page while turning to a referenced page.

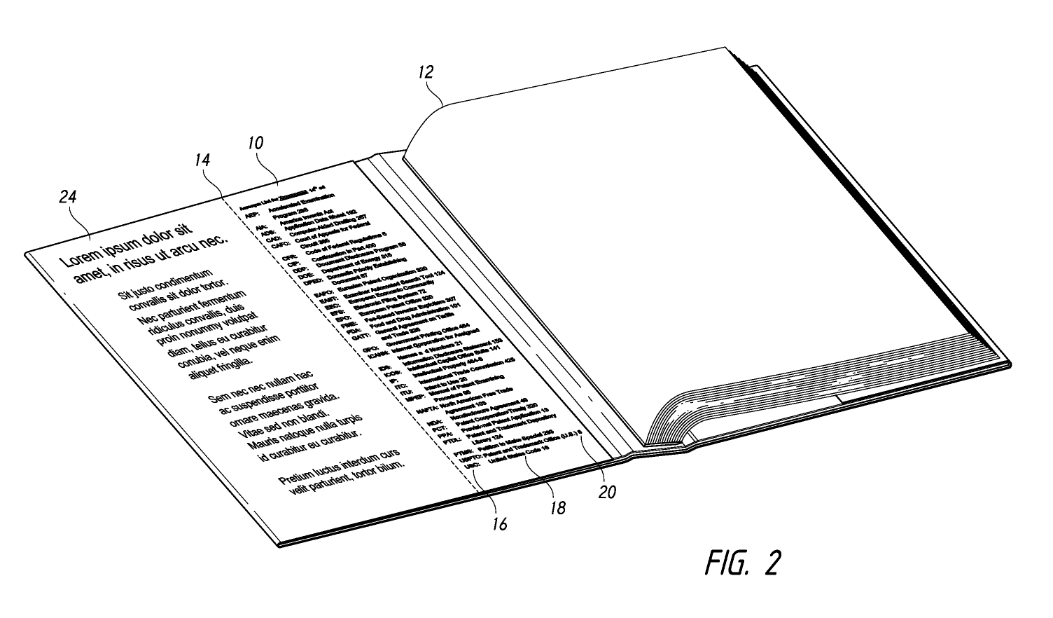

### FIGS. 2-4—Alternative Embodiments

There are various possibilities for including an acronym expansion list in a printed volume 12.

FIG. 2 illustrates another embodiment consisting of a separable card 10 attached to a printed dust jacket 24, relating to a printed volume 12, and separable at a line of perforations 14.

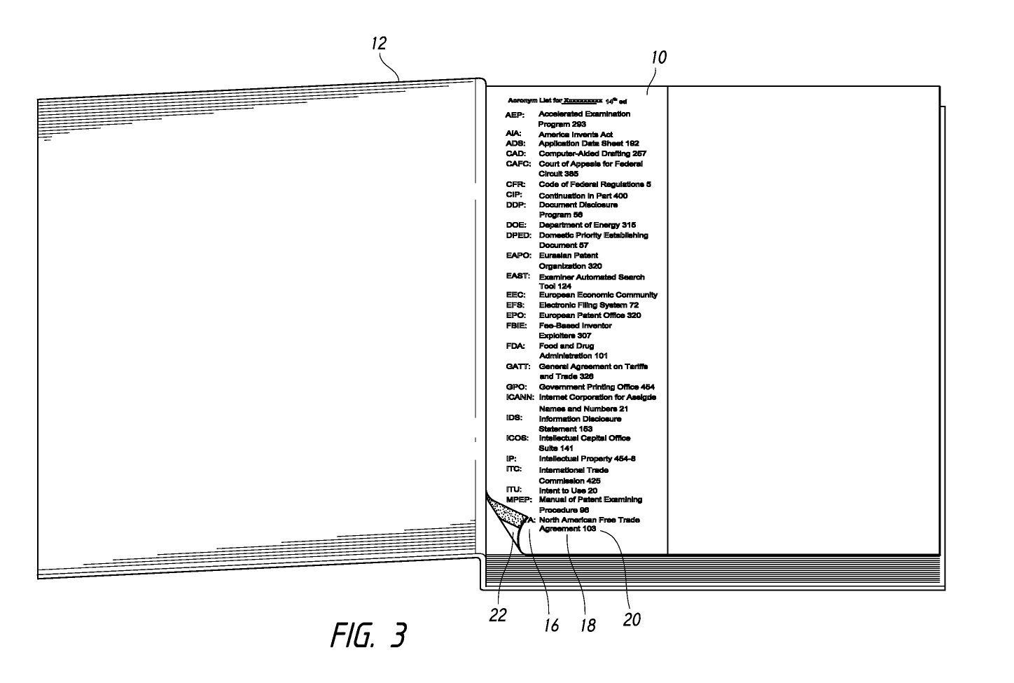

FIG. 3 represents an additional embodiment consisting of a separable card 10, attached to a printed volume 12 by means of releasable adhesive 22.

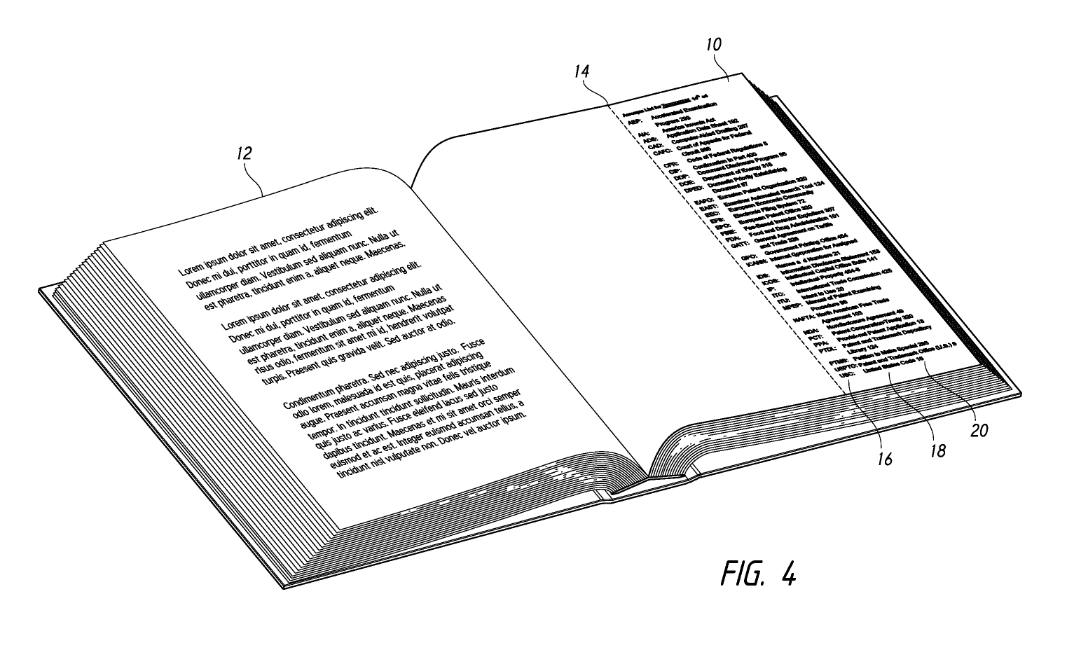

FIG. 4 represents an embodiment in which a separable card 10 is attached to a printed volume 12 at the juncture between two sections or chapters, and separable at a line of perforations 14.

FIG. 5 shows a detached acronym expansion list.

My acronym expansion list may also be printed on permanently attached pages of a printed volume 12 in addition to or in lieu of being printed on a separable card 10.

Another feature of my acronym expansion list, not illustrated in the drawing figures, is the optional use of color coding to immediately distinguish one pre-printed list of acronyms from acronym lists for other sections of the printed volume.

### CONCLUSION

Readers, novices or experts of any subject, will benefit from this quick reference. For example; while it is common knowledge that DNA is our genetic stuff, biology and medical students are required to know how to spell deoxyribonucleic acid; they will also have to remember acronyms for the base pairs AT and GC (adenosine—thymine and guanine—cytosine) that form the double helix. My embodiment, which I have trademarked, will be a boon to students.

My acronym expansion list may be embodied in other forms without departing from the spirit or essential attributes thereof. Accordingly, reference should be made to the following claims, rather than to the foregoing specification, as indicating the scope of the invention.

I claim:

1. An acronym expansion list which comprises,
a. a pre-printed list bound or furnished with a printed volume and
b. detachable or removable from said printed volume and
c. capable of being used as a reading place marker and
d. contains full wording of the phrases associated with each listed acronym:
whereby a user can quickly locate the expansion of a particular acronym.

2. The pre-printed list of claim 1 wherein said pre-printed list contains correlation between acronyms from one language to associated phrases in another language.

3. The pre-printed list of claim 1 wherein said pre-printed list contains page number indexing of said expansion phrase:
whereby a user may quickly access more information regarding an acronym.

4. The pre-printed list of claim 1 wherein said pre-printed list is color coded to immediately distinguish it from other pre-printed lists for other sections of said printed volume.

5. An acronym expansion list which comprises,
a. a list of acronyms printed on one or both inside covers of a printed volume or
b. on one or more sides of dustcovers of said printed volume or
c. on the first and/or last page of said printed volume:
whereby a user can quickly locate said expansion of a particular acronym.

6. An acronym expansion list which comprises, pre-printed list of acronyms used with a printed volume wherein said pre-printed list of acronyms is:
a. a list of acronyms printed on one or both sides of a paper sheet and
b. inserted within a printed volume or
c. provided after purchase of said printed volume or
d. printed on permanently attached pages of said printed volume in addition to being printed on removable sheets:
whereby said user can quickly locate said expansion of a particular acronym.
